(19) United States
(12) Patent Application Publication
(10) Pub. No.: US 2021/0266382 A1
(43) Pub. Date: Aug. 26, 2021

(54) SYSTEM, METHOD, AND COMPUTER PROGRAM FOR ESTABLISHING AN OVER THE AIR (OTA) COMMUNICATION CHANNEL BETWEEN A COMMUNICATION SERVICE PROVIDER AND A USER DEVICE

(71) Applicant: Amdocs Development Limited, Limassol (CY)

(72) Inventors: Ofer Hermoni, Tenafly, NJ (US); Nimrod Blumkine, Givatayim (IL)

(21) Appl. No.: 16/799,456

(22) Filed: Feb. 24, 2020

(51) Int. Cl. H04L 29/08; H04L 29/06

(52) U.S. Cl. CPC H04L 67/34; H04L 63/0876; H04L 67/2823; H04L 67/146

(57) ABSTRACT

As described herein, a system, method, and computer program are provided for establishing an over the air (OTA) communication channel between a communication service provider (CSP) and a user device. In use, the CSP establishes an over the air (OTA) communication session with the user device. Additionally, the CSP uses the OTA communication session to send information to the user device for storage thereof on the user device. Further, the CSP accesses data stored by the user device, using the information stored on the user device.

### FIELD OF THE INVENTION

The present invention relates to communication protocols used by communication service providers (CSPs).

### BACKGROUND

To date, communication service providers (CSPs) have been limited in their ability to communicate with the devices of their customers. For example, CSPs are unable to communicate with the operating system or applications on the customer devices. Now, as CSPs are performing digital transformations to their businesses to provide data and content services on top of their communication services, it would be useful for CSPs to have an established communication protocol with the devices of their customers in order to support the provisioning of the data and content services to the customer devices.

There is thus a need for addressing these and/or other issues associated with the prior art.

### SUMMARY

As described herein, a system, method, and computer program are provided for establishing an over the air (OTA) communication channel between a communication service provider (CSP) and a user device. In use, the CSP establishes an over the air (OTA) communication session with the user device. Additionally, the CSP uses the OTA communication session to send information to the user device for storage thereof on the user device. Further, the CSP accesses data stored by the user device, using the information stored on the user device.

### BRIEF DESCRIPTION OF THE DRAWINGS

FIG. 1 illustrates a method for establishing an over the air (OTA) communication channel between a communication service provider (CSP) and a user device, in accordance with one embodiment.

FIG. 2 illustrates a system flow diagram for establishing an over the air (OTA) communication channel between a communication service provider (CSP) and a user device, in accordance with one embodiment.

FIG. 3 illustrates a method for accessing data stored on a user device via an OTA channel for use by a CSP, in accordance with an embodiment.

FIG. 4 illustrates a network architecture, in accordance with one possible embodiment.

FIG. 5 illustrates an exemplary system, in accordance with one embodiment.

### DETAILED DESCRIPTION

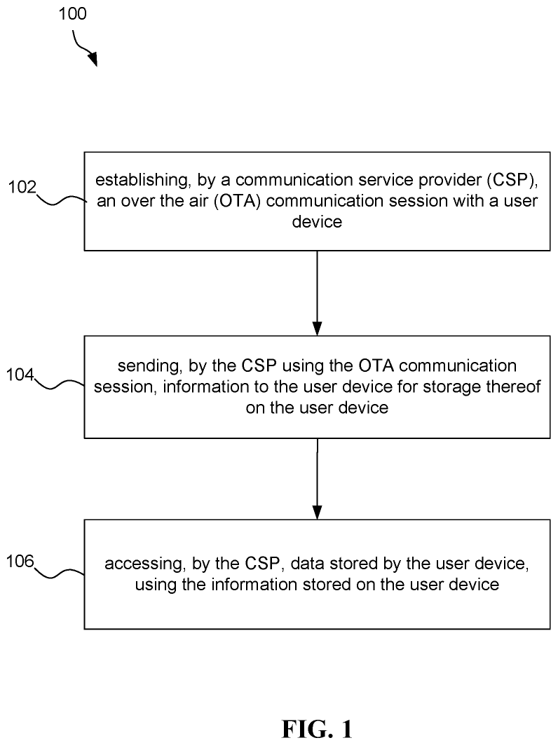

FIG. 1 illustrates a method 100 for establishing an over the air (OTA) communication channel between a communication service provider (CSP) and a user device, in accordance with one embodiment. In the context of the present description, the CSP is any system that provides a communication service for use by the user device and/or any other user devices. The communication service is usable to transport information to and from the user device. For example, the CSP may provide telecommunication (wired or wireless), Internet, cable, or other communication services.

Also in the context of the present description, the user device may be any computing device of a user that is capable of being used and/or operated by the user. For example, the user device may be a mobile phone, set top box, tablet, etc. In an embodiment, the user may be a customer of the CSP.

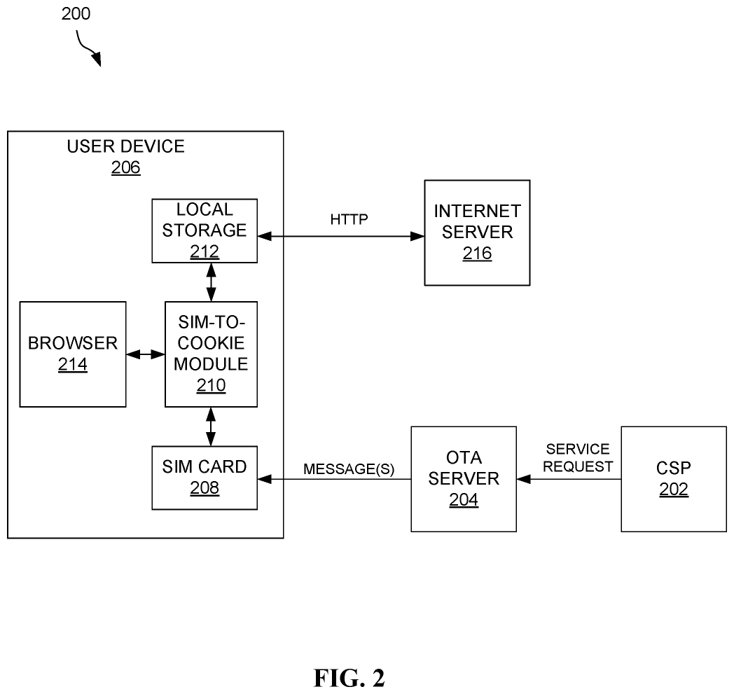

As shown in operation 102, the CSP establishes an over the air (OTA) communication session with the user device. This may be accomplished by using OTA technology to open a connection with the user device. In general, OTA is a technology (standard) for the transmission and reception of application-related information over a communication system. OTA enables the CSP to access the user device, and in one embodiment in particular the SIM card of the mobile device. More information regarding OTA technical will provided below with reference to FIG. 2.

Additionally, as shown in operation 104, the CSP uses the OTA communication session to send information to the user device for storage thereof on the user device. In one embodiment, the information is a cookie. The cookie refers to a HyperText Transfer Protocol (HTTP) cookie (also referred to as a web cookie, Internet cookie, or browser cookie). In general, the cookie is a data structure established to store various data and capable of changing the data stored therein. More information regarding the cookie and possible methods for its use will provided below with reference to FIG. 2.

In another embodiment, the information is an application or other computer code. For example, the application may be configured to gather and store certain data. The user device may execute the application as configured by the application. More information regarding the application and possible methods for its use will provided below with reference to the subsequent figures.

Further, as shown in operation 106, the CSP accesses data stored by the user device, using the information stored on the user device. To this end, the CSP may use the OTA session to store information on the user device that is then used to access other data stored by the user device. This may provide an OTA channel by which the CSP can access the data stored by the user device for various purposes.

In one embodiment where the information sent by the CSP to the user device is the cookie, the data accessed by the CSP may be stored in the cookie. In another embodiment where the information sent by the CSP to the user device is the application, the data accessed by the CSP may be data that has been stored by the application. In yet another embodiment where the information sent by the CSP to the user device is the application, the application itself may be executed to access the data for the CSP.

As noted above, the data of the user device may be accessed by the CSP for various purposes. In one embodiment, the CSP may use the data to perform multi-factor authentication for the user device. In another embodiment, the CSP may use the data to provide a content service to the user device (e.g. customized content for the user device, etc.). In a further embodiment, the CSP may use the data to provide a data service to the user device (e.g. customized data plan for the user device, etc.). These embodiments and more will be described in detail below with reference to the subsequent figures.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

FIG. 2 illustrates a block diagram of a system 200 for establishing an over the air (OTA) communication channel between a communication service provider (CSP) and a user device, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, a CSP 202 establishes an OTA session with a user device 206. In general, OTA is a technology (standard) for the transmission and reception of application-related information over a communication system. Using OTA, the CSP 202 can perform various new software updates, configuration settings, and even the update of encryption keys to the user device 206. OTA technology also enables the CSP 202 to introduce new SIM services and to modify OTA content of SIM cards in a rapid and cost-effective way.

OTA is based on a client/server architecture where at one end there is the CSP's 202 back-end system (e.g. support system, billing system and/or application server) and at the other end there is a SIM card 208 of the user device 206. The CSP's 202 back-end system sends service requests to an OTA server 204 (gateway) which transforms the requests into Short Messages and sends them onto a Short Message Service Centre (SMSC) (not shown) which transmits them to the SIM card 208.

On the user device 206, Short Messages with a protocol identifier set to “SIM data download” are delivered by the user device 206 to the SIM card 208 (e.g., ENVELOPE or UPDATE RECORD commands, etc.). The Global System for Mobile Communications (GSM) to 5G application of the user device 206 (not shown) receives those commands and calls the OTA layer of the mobile device 206 (not shown).

The OTA layer checks the Short Messages according to the GSM 03.48 or 3GPP Technical Specification (TS) 23.048 (i.e. a security layer based on cryptographic services). Each secured packet in the Short Messages may contain one or more Application Protocol Data Unit (APDU) commands dedicated to Remote File Management or Remote Applet Management or Universal Subscriber Identity Module (USIM)/Universal Integrated Circuit Card (UICC). The Remote File Management (RFM) is enabled to execute Entity Framework (EF) management commands (e.g. SELECT, UDPATE RECORD, DEACTIVATE FILE, VERIFY PIN, etc.). The Remote Applet Management (RAM) is enabled to execute applet management commands (e.g. LOAD, INSTALL, DELETE, GET STATUS, etc.).

In the present embodiment, the CSP 202 uses the OTA session established with the user device 206 to send information to the user device 206 for storage thereof on the user device. The information may be sent as a request (e.g. service request) that is received by the OTA server 204. The OTA server transforms the request into a short message(s) for the user device 206, where the short message includes the information. The OTA server sends the information in the short message(s) to the SIM card 208 of the user device 206. The information may be a cookie or an application, for example.

The information is accordingly stored in the SIM card 208 of the user device 206. In turn, the information may be moved from the SIM card 208 into another local storage 212 of the user device 206. For example, where the information is the cookie, a SIM-to-cookie module 210 may store the cookie in the local storage 212 of the user device 206. In this way, one or more web applications running on an Internet server 216 or any number of Internet servers may access the cookie to store information therein, for example. In another embodiment, a browser 214 of the user device 206 may also be provided with the cookie for use in storing information therein.

In the context of the present embodiment, the cookie is a small data structure capable of storing data therein. For example, the cookie may store a name (identifier of the cookie), a value, and zero or more attributes (e.g. name/value pairs that store information as the cookie's expiration, domain, and flags indicating secure or HTTP only).

In general, cookies are designed to be a reliable mechanism for websites to remember state-full data (such as items added in the shopping cart in an online store) or to record the user's browsing activity (including clicking particular buttons, logging in, or recording which pages were visited in the past). They can also be used to remember arbitrary pieces of data that the user previously entered into form fields such as names, addresses, passwords, and credit card numbers. The data is stored locally on the user's device 206 (usually browser 214) and the data is used by the same website when the user is browsing the website again.

Still yet, the CSP 202 uses the information (e.g. cookie) to access data stored by the user device 206. For example, the CSP 202 may access (e.g. retrieve) data stored in the cookie. As another example, such as where the information is an application, the CSP 202 may access data stored by the application or may use the application itself to access data stored on the user device 206 (e.g. either in the SIM card 208 or the local storage 212).

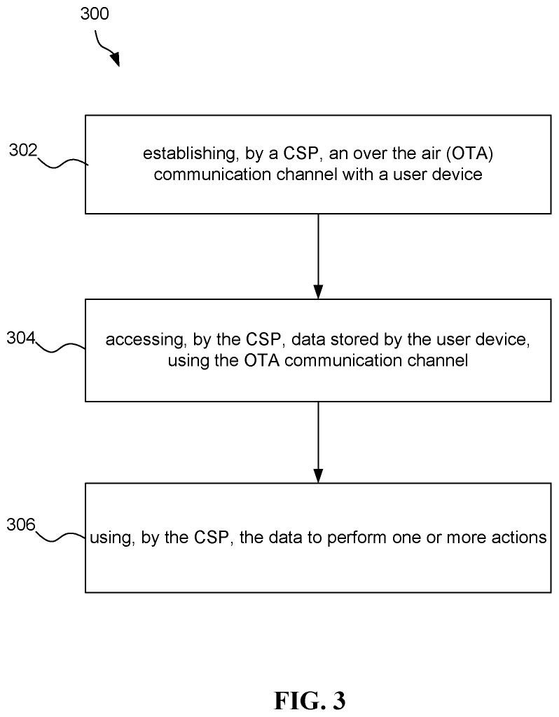

FIG. 3 illustrates a method 300 for accessing data stored on a user device via an OTA channel for use by a CSP, in accordance with an embodiment. As an option, the method 300 may be carried out in the context of the details of the previous figure and/or any subsequent figure(s). Of course, however, the method 300 may be carried out in the context of any desired environment. Further, the aforementioned definitions may equally apply to the description below.

As shown in operation 302, a CSP establishes an OTA communication channel with a user device. The OTA communication channel may be established using operations 102-104 of FIG. 1 described above. For example, the OTA communication channel may be established by the CSP storing a cookie, application, or other data on the user device using OTA technology.

Additionally, in operation 304, the CSP accesses data stored by the user device using the OTA communication channel. For example, the CSP may access data stored in the cookie or stored by the application. Further, in operation 306, the CSP uses the data to perform one or more actions.

In one embodiment, the OTA communication channel may be established by the CSP storing a cookie on the user device. This OTA communication channel that is controlled by the CSP regardless of user activity (whether he is browsing a certain site or not) can be used to push cookies or other data to the user device that can influence application and browser behavior ranging from personalized commercials.

In another embodiment, the OTA communication channel may be established by the CSP for use in providing two factor authentication for websites and/or user applications. In general, two factor authentication is a method of confirming a user's claimed identity by using a combination of two different factors: 1) something the user knows, 2) something the user has, or 3) something the user is. One very popular example for mobile phone based two factor authentication is to send the user an SMS with a one-time code, where the user uses that code to access an application/website. This type of two factor authentication is prone to being easy to manipulate and attack. By using the OTA communication channel, the one-time code may be sent from the CSP network (not via SMS) to the user device, and then may be automatically retrieved by the website/application via the local memory that has been updated with the one-time code via the OTA channel.

In an additional embodiment, the OTA communication channel may be established by the CSP to provide a multipurpose communication memory between the CSP and the user device, namely to allow the CSP access to the operating system (including its services) of the user device and the applications of the user device.

In an embodiment, the SIM toolkit application of the user device may be open by default and may have extensive permissions that are enabled by default. This may allow the CSP to access the SIM card of the user device via the OTA communication channel and thus access data of the user device, while avoiding traditional costs associated with application development and deployment to the user device to achieve the same purpose. Moreover, in at least some embodiments there is no need for active user involvement like loading an application from the market, so a time to market is instant when using the OTA communication channel described above.

In a further embodiment, pushing a cookie to the user device can be triggered by CSP decisions and may not be only dependent on the browsing habits of the user. For example, using the OTA communication channel, the cookie may be pushed to the user device such that when changing a network to roaming, the cookie can trigger a particular advertisement (e.g. for trip insurance).

In additional embodiments, the OTA communication channel can be used to gather various states from the user device which are serialized into a cookie. This cookie can be read by various affiliates of the CSP to bring value. For example, users who apparently are daily commuters and are approaching the age eligible for driving license can be targeted by driving schools advertisements.

In still yet another embodiment, the OTA communication channel can be used to read third party browser cookies stored on the user device by an affiliate, and can then be used for personalization of customer services. For example, if a customer is browsing sites that are related to selling smart phones and on affiliate network, the CSP can proactively contact the client and suggest a deal on a handset.

Further, in an embodiment, the OTA communication channel can be used in HTTP-less communication scenarios using short message service (SMS) and can interface with the user device browser and applications. For example, broadcasting a public service message as the lowest common denominator will open the default browser with evacuation instructions without requiring the user to install an particular application or actively download an application.

In an embodiment, by using the same mechanism that read and writes propriety cookies to gather data on existing third party cookies, the OTA communication channel can be used as a Cookies' Sniffer gathering data and statistics on other services that are used by the user device and that utilize cookie serialization. This allows the CSP to learn and report about the user device usage and consumed services, as well as allow centrally managed policies over other parties' cookies stored on the user device.

Moreover, an embodiment may relate to an electronic SIM (eSIM) based user device, which includes an environment that basically extends the dual SIM to multiple SIM profiles that can be managed dynamically by users to connect simultaneously, or in stand-by mode, to multiple CSPs. There may be no limitation to the number of CSP profiles that can be connected by the user to a Consumer Solution eSIM. In this environment, one can expect that different subscription profiles in the eSIM's electronic UICC (eUICC) profile management component will be used for different purposes. For example, one CSP profile may be used for roaming, another different CSP profile may be used for video broadcast, and another for work related communications. This OTA communication channel can provide:

1. State/status based communications between different CSP profiles on the devices that are isolated from each other from security reasons, by using a predefined cookies mechanism.

2. A dedicated CSP profile for providing the OTA communication channel alone, without need for the user to commit to another CSP for all other operations.

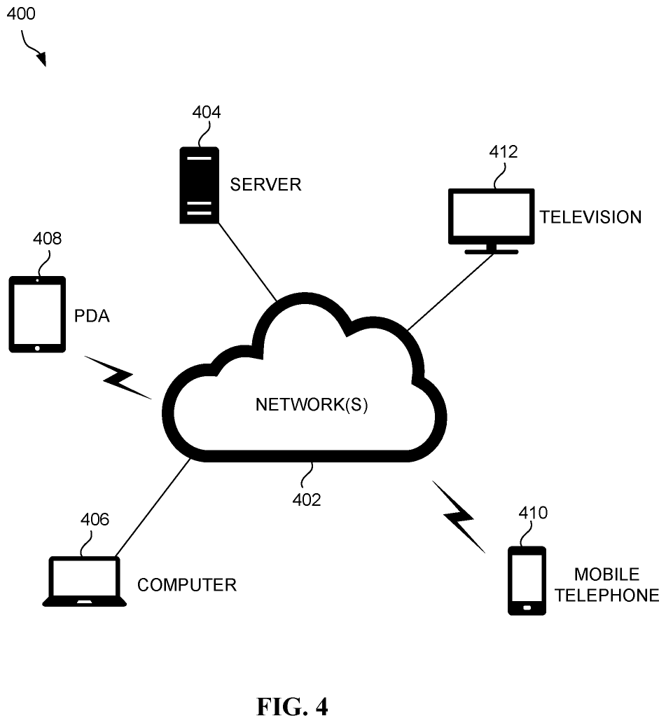

FIG. 4 illustrates a network architecture 400, in accordance with one possible embodiment. As shown, at least one network 402 is provided. In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of devices. For example, a server computer 404 and an end user computer 406 may be coupled to the network 402 for communication purposes. Such end user computer 406 may include a desktop computer, lap-top computer, and/or any other type of logic. Still yet, various other devices may be coupled to the network 402 including a personal digital assistant (PDA) device 408, a mobile phone device 410, a television 412, etc.

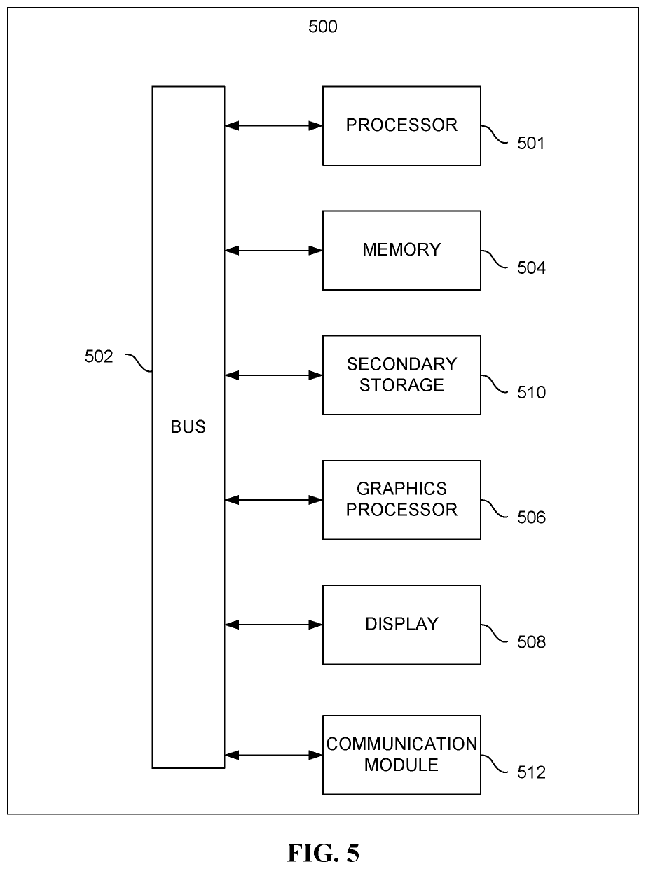

FIG. 5 illustrates an exemplary system 500, in accordance with one embodiment. As an option, the system 500 may be implemented in the context of any of the devices of the network architecture 400 of FIG. 4. Of course, the system 500 may be implemented in any desired environment.

As shown, a system 500 is provided including at least one central processor 501 which is connected to a communication bus 502. The system 500 also includes main memory 504 [e.g. random access memory (RAM), etc.]. The system 500 also includes a graphics processor 506 and a display 508.

The system 500 may also include a secondary storage 510. The secondary storage 510 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 504, the secondary storage 510, and/or any other memory, for that matter. Such computer programs, when executed, enable the system 500 to perform various functions (as set forth above, for example). Memory 504, storage 510 and/or any other storage are possible examples of non-transitory computer-readable media.

The system 500 may also include one or more communication modules 512. The communication module 512 may be operable to facilitate communication between the system 500 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer readable medium storing computer code executable by a processor to perform a method comprising:
establishing, by a communication service provider (CSP), an over the air (OTA) communication session with a user device;
sending, by the CSP using the OTA communication session, information to the user device for storage thereof on the user device;
accessing, by the CSP, data stored by the user device, using the information stored on the user device.

2. The non-transitory computer readable medium of claim 1, wherein the information is a cookie.

3. The non-transitory computer readable medium of claim 2, wherein the data accessed by the CSP is stored in the cookie.

4. The non-transitory computer readable medium of claim 1, wherein the information is an application.

5. The non-transitory computer readable medium of claim 4, wherein the data accessed by the CSP is stored by the application.

6. The non-transitory computer readable medium of claim 4, wherein the application accesses the data for the CSP.

7. The non-transitory computer readable medium of claim 1, further comprising:
using, by the CSP, the data to perform multi-factor authentication for the user device.

8. The non-transitory computer readable medium of claim 1, further comprising:
using, by the CSP, the data to provide a content service to the user device.

9. The non-transitory computer readable medium of claim 1, further comprising:
using, by the CSP, the data to provide a data service to the user device.

10. The non-transitory computer readable medium of claim 1, wherein the information is sent as a request to an OTA gateway that transforms the request into a short message for the user device, the short message including the information.

11. The non-transitory computer readable medium of claim 10, wherein the short message is transmitted by the OTA gateway to a subscriber identity module (SIM) card of the user device.

12. The non-transitory computer readable medium of claim 11, wherein the information is stored in the SIM card of the user device.

13. The non-transitory computer readable medium of claim 12, wherein the information moved from the SIM card of the user device to another local storage of the user device.

14. The non-transitory computer readable medium of claim 1, wherein the user device is a mobile phone.

15. The non-transitory computer readable medium of claim 1, wherein the user device is a device of a customer of the CSP.

16. A method, comprising:
establishing, by a communication service provider (CSP), an over the air (OTA) communication session with a user device;
sending, by the CSP using the OTA communication session, information to the user device for storage thereof on the user device;
accessing, by the CSP, data stored by the user device, using the information stored on the user device.

17. The method of claim 1, further comprising:
using, by the CSP, the data to perform multi-factor authentication for the user device.

18. The method of claim 1, further comprising:
using, by the CSP, the data to provide a content service to the user device.

19. The method of claim 1, further comprising:
using, by the CSP, the data to provide a data service to the user device.

20. A system of a communication service provider (CSP), comprising:
a non-transitory memory storing instructions; and
one or more processors in communication with the non-transitory memory that execute the instructions to perform a method comprising:
establishing, by the CSP, an over the air (OTA) communication session with a user device;
sending, by the CSP using the OTA communication session, information to the user device for storage thereof on the user device;
accessing, by the CSP, data stored by the user device, using the information stored on the user device.
